(19) United States
(12) Patent Application Publication
(10) Pub. No.: US 2003/0030567 A1
(43) Pub. Date: Feb. 13, 2003

(54) Flexible functionality of stack light

(76) Inventors: William Hieby Hetzel, Cheshire, CT (US); Geoffrey Hugh McKay, West Hartford, CT (US); David James Lesslie, Plainville, CT (US); Senya Marie Hiscox Miles, Middletown, CT (US); Michael Constantin von Kannewurff, Middlebury, CT (US); Joseph Patrick Smith, Dorchester, MA (US)

Correspondence Address: CANTOR COLBURN, LLP, 55 GRIFFIN ROAD SOUTH, BLOOMFIELD, CT, 06002

(21) Appl. No.: 09/682,271

(22) Filed: Aug. 13, 2001

(51) Int. Cl. G08B 5/00

(52) U.S. Cl. 340/815.4; 340/815.52; 340/331

(57) ABSTRACT

A stack light having both steady and flashing light capabilities is disclosed. In an exemplary embodiment, the light stack or signaling light beacon comprises a light module containing a socket for a lamp, circuitry for operating the light module, and a jumper connector connected to the circuitry for selecting between flashing and steady light within the light module.

### BACKGROUND OF INVENTION

The present invention relates generally to signaling stack lights, and more particularly, this invention relates to stack lights which embody both steady and flashing light capabilities.

Signaling lights which are arrangeable in stacks of separate modules to provide illumination of different colors suitable for use in industrial plants and factories to indicate the status (operating condition) of assembly lines and other apparatus therein are commercially available. Such devices are also termed stack lights, stackable beacons, and signal towers. Such lights may be made up of modules which may be stacked in a vertical array and provided with structural rigidity to withstand vibration and mechanical impacts as may exist in industrial environments. The modules can typically be arranged individually on a base or in a stack of one module above the other.

Status indicating lights provide information at a glance in industrial or commercial environments where there is a need to visually transmit and receive information across a distance. A typical application of a status indicating light might be a stack light mounted on the enclosure of an automated machine. For example, using a three high stack light, a machinery manufacturer might wire a top red light to indicate the machine is shut down. An amber light could be wired to indicate low level of raw material feeding the machine, and a green light might show the machine running normally. Using such a stack light, a supervisor in an automated factory can see from anywhere on the factory floor if a machine needs attention. In addition to the industrial product/process OEM and end-user market, such a stack light may also be used in many commercial environments.

Such signaling devices are particularly effective in environments where the level of background noise is very high and there is a danger that an audible alarm will not be heard. Furthermore, the signaling devices can distinguish between various malfunctioning conditions by relating different conditions to different colors of lights or to different frequencies of flashing lights. In a crowded factory, a system of signaling devices enables maintenance people to quickly locate and identify specific problems in a large number of operating machines. Such a system is extremely effective and efficient because it enables a single individual to monitor a large number of machines from a distance where the operating status of all the machines can be simultaneously observed.

Current stack light offerings in the market offer steady light functionality as the standard feature. The flash (blinking) functionality is achieved through an external “kit” to the stack light. The problem with current stack light offerings is that the flashing (blinking) function of the light bulbs is achieved through an external kit or component, requiring the need to order, design, manufacture, assemble, and pay for an extra component to the stack light itself.

### SUMMARY OF INVENTION

The above discussed and other drawbacks and deficiencies of the prior art are overcome or alleviated by a signaling light beacon of this invention.

In an exemplary embodiment of this invention, the signaling light beacon comprises a light module containing a socket for a lamp, circuitry for operating the light module, and a jumper connector connected to the circuitry for selecting between flashing and steady light within the light module.

### BRIEF DESCRIPTION OF DRAWINGS

Referring to the exemplary drawings wherein like elements are numbered alike in the several FIGURES:

FIG. 1 is a perspective view of the light beacon of this invention with five light modules;

FIG. 2 is a perspective view of the light beacon of this invention with six light modules;

FIG. 3 is a circuit diagram of circuitry for the light beacon of FIGS. 1 and 2;

FIG. 4 is a circuit diagram of alternate circuitry for the light beacon of FIGS. 1 and 2;

FIG. 5 is a front plan view of a jumper connector for use within the circuitry of FIG. 3 or 4;

FIG. 6 is a bottom plan view of the jumper connector of FIG. 5;

FIG. 7 is a top plan view of the jumper connector of FIG. 5;

FIG. 8 is a side plan view of the jumper connector of FIG. 5;

FIG. 9 is a top plan view of a grid for use within the circuitry of FIG. 3 or 4;

FIG. 10 is a front side plan view of the grid of FIG. 9;

FIG. 11 is a right side plan view of the grid of FIG. 9;

FIG. 12 is a front plan view of the jumper connector of FIG. 5 installed on the grid of FIG. 10;

FIG. 13 is a right side plan view of jumper connectors installed on the grid;

FIG. 14 is a top plan view of jumper connectors selectively installed on the grid of FIG. 9;

FIG. 15 is a perspective of a printed circuit board for the light beacon of FIG. 1; and,

FIG. 16 is a perspective internal view of the base of the light beacon of FIG. 1 having receptacles for holding spare jumper connectors of FIG. 5.

### DETAILED DESCRIPTION

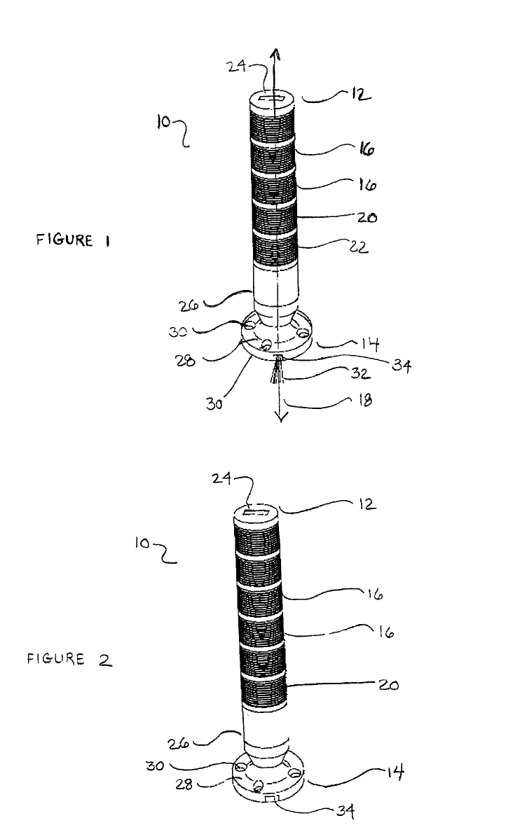

Referring to FIGS. 1 and 2, a signaling light stack or light beacon 10 is shown having a top end 12 and a bottom end 14. Light modules 16 are aligned along longitudinal axis 18 of the beacon 10. Any number of light modules 16 may be stacked upon each other to form the light beacon 10. The top end 12 of each light beacon 10 may include a cap 24 and the bottom end 14 of each light beacon 10 may include a base unit 26.

Each light module 16 preferably comprises a glass or plastic translucent colored outer cylindrical portion 20, otherwise known as a lens. Each cylindrical portion 20 within a beacon 10 is preferably a different color than the other light modules 16 within a single beacon 10. The cylindrical portions 20 may comprise red, amber, blue, green, magenta, and clear cylinders. Other colors are also within the scope of this invention. Alternatively, each cylindrical portion 20 may be clear and a bulb (not shown) within the cylindrical portion 20 may contain the colored element. The cylindrical portion 20 may also include ridges 22 to improve reflectivity and structural rigidity. Although cylindrical portions 20 are shown as the lenses for the light beacon 10, it is within the scope of this invention to utilize alternative shapes for the lenses. For example, a light beacon 10 may be mounted to the side of a machine or a wall and the lens need not encompass a full 360 degree visibility. Also, light beacons of varying diameters and heights for accommodating visibility over varying distances are within the scope of this invention.

For providing the illumination within the light beacon 10, any type of bulb (not shown) may be electrically connected within the light modules 16. For example, the light modules 16 may be illuminated by incandescent bulbs, halogen bulbs, or light emitting diodes (LED”s). Other forms of illumination known in the art would also be within the scope of this invention.

The light beacon 10 may be factory ordered and assembled, or individual parts may be ordered and assembled on site as required. Bulbs can be replaced when required. For assembly and maintenance by the customer, the light beacon 10 preferably comprises easy-to-assemble components such as a screw-on cap 24 or audible alarm (buzzer) not shown. Wires from each module 16 preferably provide electrical interconnection between the modules 16 and electrical connection with the base unit 26 may be through a screw type terminal strip, connector and socket, solder joint, or other electrical connection, within the base unit 26.

The base unit 26 may include an attaching portion 28 with a plurality of screw holes 30. As shown, the screw holes 30 have a longitudinal axis parallel with the longitudinal axis 18 of the light beacon 10. Thus, screws (not shown) may pass through the screw holes 30 and into a machine or other body for firmly securing the light beacon 10 thereto. For electrically connecting the light beacon 10 to the machine or other body, wires 32 exiting the attaching portion 28 through exit hole 34 may electrically connect to the machine or other body.

Having an individual module flash requires purchasing a flashing module within the prior art, and the module cannot be returned to steady light the flashing module must be replaced with a steady light module which requires additional parts, product shut-down, and reassembly.

This invention utilizes simple, tool-less, mechanical means (e.g. jumper connectors, or dipswitches) within the electronic components (i.e. printed circuit board) of the light beacon 10 that permits both flashing and steady functions by switching the mechanical operation connectors. Since this function is contained within the light beacon 10, no additional kit is needed, the customer can change functionality whenever it suits their needs. This invention creates significant ease of assembly and functionality.

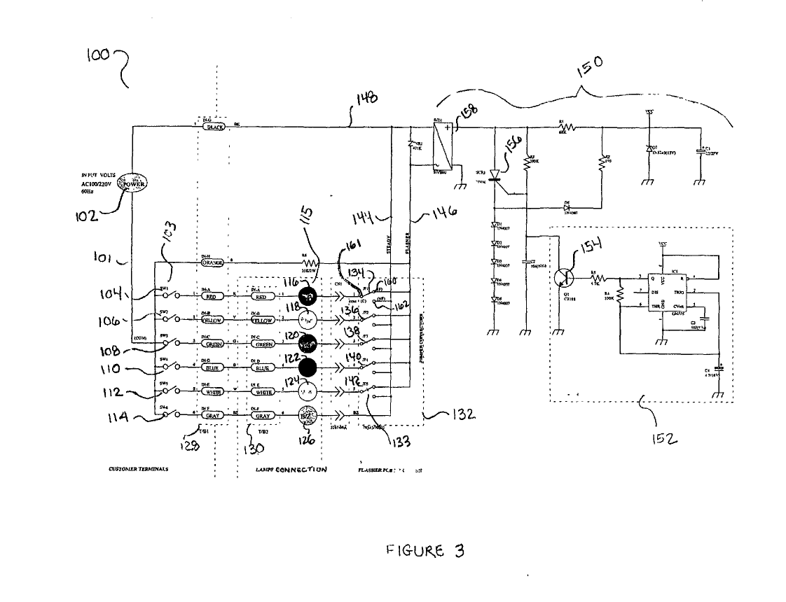

Referring to FIG. 3, exemplary circuitry 100 for use with a light beacon 10 having five light modules 16 and a buzzer 126 is shown. Power source 102 is shown running off a line. Switches 104-114, shown collectively as 103, are connected to power line 101 and are provided for individually turning on/off a selected lamp socket or buzzer, shown collectively as 115. That is, if switch 104 is closed, then power is provided to lamp socket 116, if switch 106 is closed, power is provided to lamp socket 118, etc. If switch 114 is closed, then power is provided to buzzer 126. The turning on/off of a switch is controlled by machine operations, not shown. On/off switching can be controlled by limit switches, proximity switches/sensors, thermostats, or any other detector of change within a machine operation”s condition. Such switches would be contained within a customer”s own machine or other apparatus and not within the light beacon 10. Terminal blocks 128 and 130 include numbered or color-coded connection pins/terminals. The numbers or color codes may indicate wire color or terminal color, but do not necessarily indicate bulb color, although that could be color-coded as well. Lines electrically interconnect the switches 104-114, terminals within terminal blocks 128 and 130, lamp sockets 116-124 and buzzer 126, and connector terminals 131.

Block 132 demonstrates the flasher printed circuit board and the jumper connections. For each of the five light modules, a jumper connector 134-142, shown collectively as 133, is provided for connecting the associated lamp socket 115 with either a “steady” line 144 or a “flasher” line 146. As shown in FIG. 3, each of the jumper connectors 133 is connected to the flasher line 146. Thus, a bulb within each of the lamp sockets 115 would flash when turned on (when its associated switch 103 is closed), as opposed to shining a steady light.

The steady line 144 is connected to the ground/neutral line 148 while the flasher line 146 is connected to a “flasher circuit” 150. The flasher circuit 150 may include a timer apparatus 152 which turns a transistor 154 on and off at a certain frequency. The timer apparatus 152 is connected through a SCR 156 (silicon controlled rectifier), a switching apparatus, and bridge rectifier 158 to the flasher line 146. Thus, when the jumper connector 133 is connected to the steady line 144, an associated bulb or lamp within sockets 115 will shine steady light and when the jumper connector 133 is connected to the flasher line 146, an associated bulb or lamp within sockets 115 will connect with the flasher circuit 150 for providing flashing light.

The jumper connectors 133 may comprise black plastic jumper connectors with internal electrical conductors connecting common or center (“C”) pin 161 with either the F (flashing) pin 160 or NF (not flashing) pin 162. When the jumper connector 133 is attached to the NF pin 162, the light socket 115 wired to that row remains steady when turned on. When the jumper connector 133 is attached to the F pin 160, the light socket 115 wired to that row cycles on and off in a flashing manner when turned on. The changing from one function to another (flashing to steady light and back) is very simple, through movement of the connectors 133 from pins 161 and 160 to pins 161 and 162 and back again.

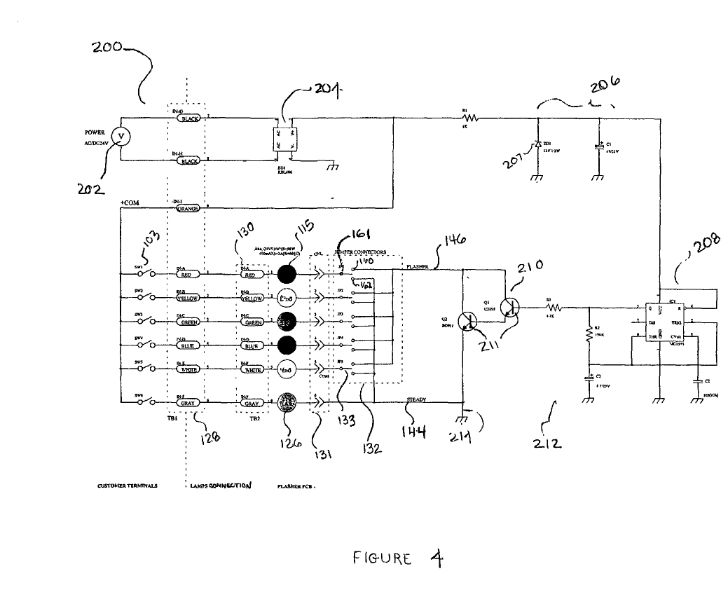

Referring now to FIG. 4, exemplary circuitry 200 for use with light beacon 10 is shown. Circuitry 200 is similar to circuitry 100, but modified for power source 202. An AC to DC bridge rectifier 204 is included and filter 206 converts ripply DC to less ripply DC using a zenor 207 which clips the voltage to a regulated voltage for supplying to the timer apparatus 208 of the flasher circuit 212 which includes a switching/control device 210 having a pair of transistors 211, which, when one transistor 211 is turned on, the other is turned on. As in circuitry 100, when jumper connector 133 is connected to pins 161 and 160, the lamp socket 115 is connected to the flasher line 146 which connects to the flasher circuit 212. When jumper connector 133 is connected to pins 161 and 162, the lamp socket 115 is connected to the steady line 144 which connects to ground 214.

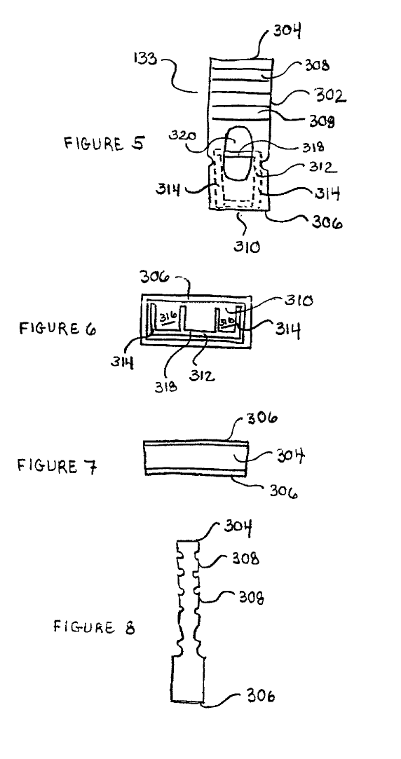

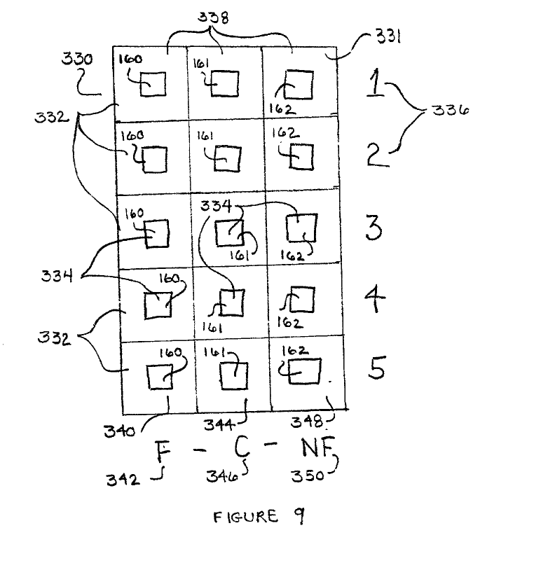

Referring now to FIGS. 5-8, an exemplary jumper connector 133 is shown. The jumper connector 133 preferably includes a plastic or other insulative body 302 having a grasping end 304 and a connecting end 306. The grasping end 304 may include ridges 308 for easier grasping and flexibility. The connecting end 306 includes an opening 310 for receiving a pair of pins, either F pin 160 and C pin 161 or NF pin 162 and C pin 161. For electrically connecting the pair of pins, an internal electrical conductor 312 is included within the connecting end 306. The internal electrical conductor 312 may include a pair of pin receivers 314, shown in phantom in FIG. 5, and a bottom view shown in FIG. 6. The pin receivers 314 are shown having a generally U-shaped cross-section, although alternate constructions are within the scope of this invention as long as an electrical connection is provided with the pin received within the pin pocket 316 formed by a combination of the pin receiver 314 and the body 302. The pin receivers 314 may be electrically connected to each other by linking bars 318, of which there may be one, two, or more or any size necessary to electrically connect pin receivers 314. Thus, current passing between a first pin and a second pin will pass from the first pin to a first pin receiver 314, to at least one linking bar 318, to a second pin receiver 314, and to the second pin. A through window 320 may be provided within the body 302 of the jumper connector 133 for flexibility and viewing of a top linking bar 318 which should generally line up with a top of an adjacent pin when the jumper connector 133 is correctly installed on a pair of pins. As shown in FIG. 7, the connecting end 306 may be a bit wider than the grasping end 304. This allows more room at the grasping end 304 for an installer to hold the grasping end 304 while installing the jumper connectors 133.

FIG. 9 shows an exemplary grid 330 usable in a flasher PCB. The grid 330 shown has five rows 332 of pins, shown collectively as pins 334, and is thus usable within a light stack 10 having five light modules 16. The pins 334 may be mounted upon a base 331 which is electrically attachable to the PCB. The rows 332 may be numbered by row indicia 336 for ease of matching a particular row 332 with a corresponding lamp socket 115. The grid 330 further includes three columns 338 of pins 334. A first column 340 includes F pins 160. First column 340 may include column indicia 342. A second column 344 includes C pins 161. Second column 344 may include column indicia 346. A third column 348 includes NF pins 162. Third column 348 may include column indicia 350. Column indicia 342 is shown to depict the letter “F” for “flashing”, column indicia 346 is shown to depict the letter “C” for “common” or “center”, and column indicia 350 is shown to depict the letters “NF” for “not flashing”. Although particular embodiments of column indicia are shown, it would be within the scope of this invention to utilize other letters or indicia, and could include any indicia suitable such as alternate indicia chosen from languages other than English.

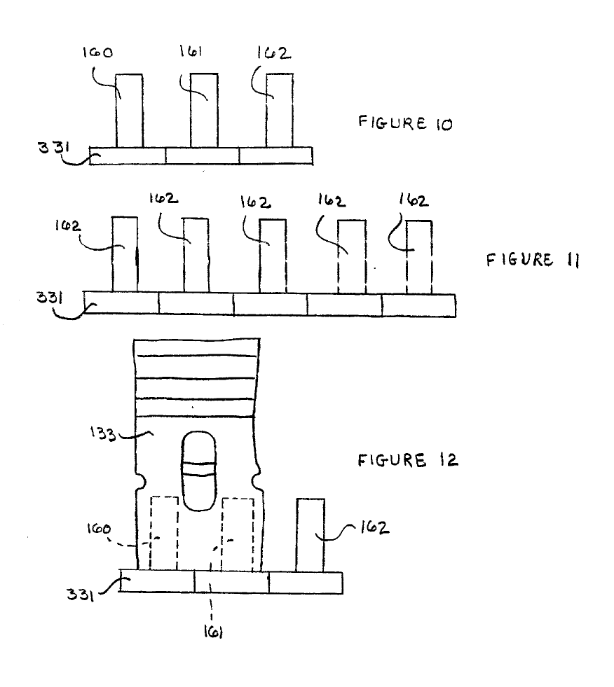

FIG. 10 shows a side view of the columns 338 of the grid 330, which includes the F pins 160, C pins 161, and NF pins 162. FIG. 11 shows a side view of the rows 332 of the grid 330. From the side depicted in FIG. 11, only pins 162 are visible.

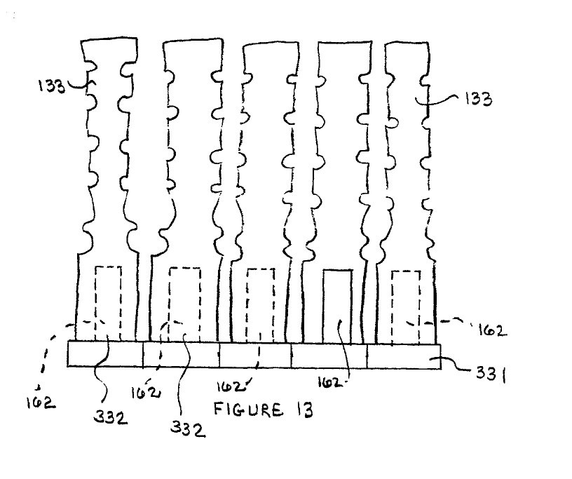

Turning now to FIG. 12, a jumper connector 133 is shown pressed onto F pin 160 and C pin 161, shown in phantom. Thus, a lamp socket 115 in line with this row 332 of pins 334 will flash when turned on. During installation of the jumper connector 133 onto the selected pins 334, the pin receivers 314 are aligned over the selected pair of adjacent pins 334 and pushed onto the grid 330 such that the selected pins 334 are snugly received within the pockets 316. Although a press-fit installation is disclosed, alternate methods of electrically connecting a pair of adjacent pins is within the scope of this invention.

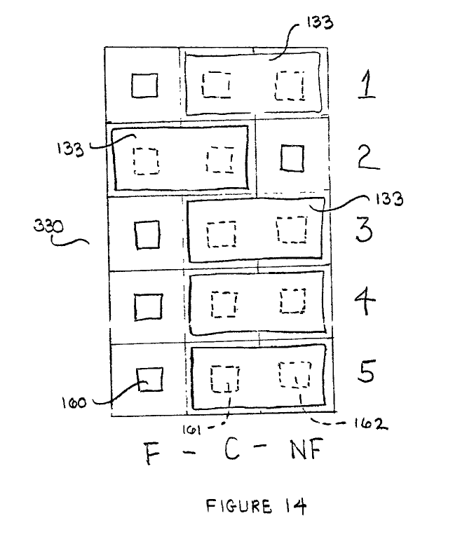

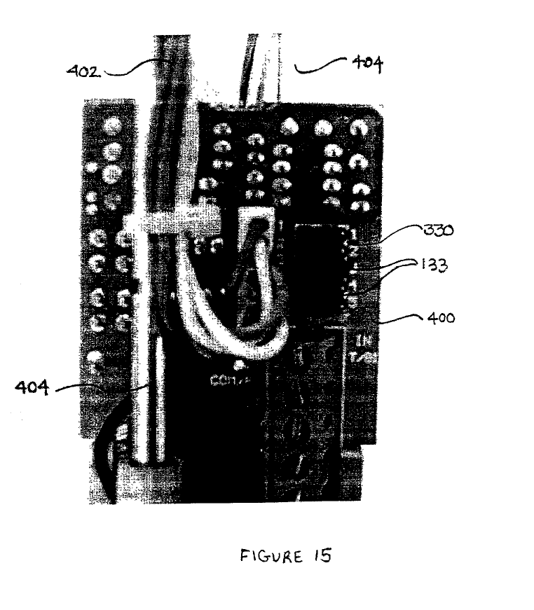

FIG. 13 shows a side view of the five rows 332 in the grid 330 with five jumper connectors 133 installed thereon and FIG. 14 shows a top view of a similarly arranged grid 330. In FIG. 13, four of the rows 332 show NF pin 162 in phantom, which indicates that the jumper connector 133 has been installed over the NF pin 162 and the C pin 161 (not shown). One of the rows (such as row “2” as shown in FIG. 14), however, shows NF pin 162 not in phantom, but the jumper connector 133 remains visible behind this NF pin 162. This indicates that the jumper connector 133 has been installed over the F pin 160 and C pin 161 within that row. From FIG. 14, it can be clearly seen that the lamp sockets 115 connected to rows 1, 3, 4, and 5 will shine steady light when turned on, and that the lamp socket 115 connected to row 2 will provide a flashing light when turned on.

FIG. 15 shows the grid 330 with a set of installed jumper connectors 133 on a PCB 400 for containment within the base unit 26. Wires 402 are shown extending from the PCB 400 and provide the electrical connection between each module 16 and the PCB 400. Rods 404 provide structural rigidity to the light beacon 10, and preferably extend the length of the light beacon 10.

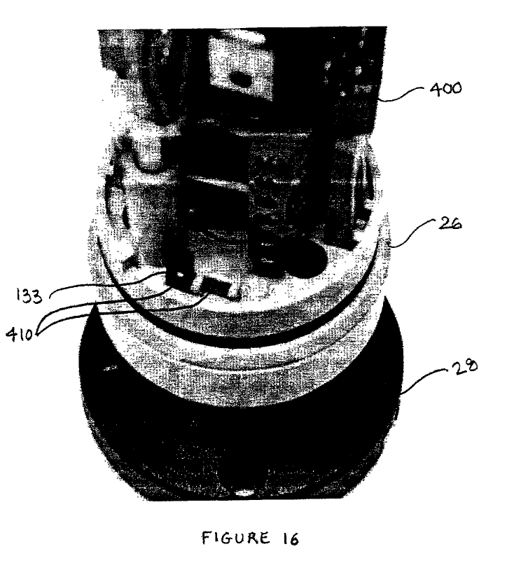

FIG. 16 shows a portion of the base unit 26 which includes a pair of adjacent receptacles 410 for snugly receiving extra or “spare” jumper connectors 133. The receptacles 410 are preferably formed from the insulating material of the outer body of the base unit 26 and sized for a snug fit of the jumper connectors 133. Thus, should one of the jumper connectors 133 used on the grid 330 become misplaced or damaged, a spare jumper connector 133 could be retrieved from a receptacle 410.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. Circuitry for a signaling light stack, the circuitry comprising:
a plurality of lamp connections;
a first line connected to ground;
a flasher circuit;
a second line connected to the flasher circuit; and,
a jumper connector for each lamp connection, each jumper connector selectively joining the lamp connection with either the first line or the second line;
wherein, when a jumper connector is moved to connect a lamp connection with the first line, an associated lamp will shine steady, and, when a jumper connector is moved to connect a lamp connection with the second line, an associated lamp will flash.

2. The circuitry of claim 1 further comprising a power line, wherein each lamp connection connects with the power line for either providing power to or disconnecting power from each lamp connection.

3. The circuitry of claim 2 further comprising a bridge rectifier for converting AC to DC power.

4. The circuitry of claim 3 further comprising a filter interconnected between the DC power source and the flasher circuit.

5. The circuitry of claim 1 further comprising a timer apparatus within the flasher circuit for providing a frequency of flashing within an associated lamp.

6. The circuitry of claim 5 wherein the timer apparatus includes a transistor which is turned on and off at the frequency.

7. The circuitry of claim 1 further comprising a grid of pins, the grid having a row of pins for each lamp connection, the grid further having three columns of pins, a first column of pins connected to the second line, a second column of pins connected to the lamp connections, and a third column of pins connected to the first line, and further wherein each jumper connector includes an internal electrical conductor for electrically connecting an adjacent pair of pins within each row.

8. The circuitry of claim 7 wherein the internal electrical conductor comprises a pair of pin receivers connected by a linking bar.

9. The circuitry of claim 7 wherein each jumper connector comprises a body of insulative material, the internal electrical conductor positioned within the body.

10. The circuitry of claim 7 wherein the grid is positioned on a printed circuit board.

11. The circuitry of claim 7 wherein the jumper connectors are retained on an adjacent pair of pins by a press-fit connection.

12. A signaling light beacon comprising:
a light module containing a socket for a lamp;
circuitry for operating the light module; and,
a jumper connector connected to the circuitry for selecting between flashing and steady light within the light module.

13. The signaling light beacon of claim 12 wherein the circuitry comprises:
a lamp connection;
a first line connected to ground;
a flasher circuit; and,
a second line connected to the flasher circuit;
wherein the jumper connector is selectively movable between the first line and the second line and wherein, when the jumper connector is moved to connect the lamp connection with the first line, an associated lamp will shine steady, and, when the jumper connector is moved to connect the lamp connection with the second line, an associated lamp will flash.

14. The signaling light beacon of claim 13 further comprising a base unit.

15. The signaling light beacon of claim 14 wherein the base unit houses the circuitry and the jumper connector.

16. The signaling light beacon of claim 12 comprising a plurality of light modules stacked along a longitudinal axis of the signaling light beacon.

17. The signaling light beacon of claim 16 wherein each light module comprises a differently colored translucent lens.

18. The signaling light beacon of claim 17 wherein the lens of each light module is cylindrically shaped.

19. The signaling light beacon of claim 17 wherein the lens of each light module includes ridges.

20. The signaling light beacon of claim 16 wherein each light module comprises a differently colored lamp.

21. The circuitry of claim 13 further comprising a grid of pins, the grid having a row of pins for each lamp connection, the grid further having three columns of pins, a first column of pins connected to the second line, a second column of pins connected to the lamp connections, and a third column of pins connected to the first line, and further wherein each jumper connector includes an internal electrical conductor for electrically connecting an adjacent pair of pins within each row.

22. The circuitry of claim 21 wherein the internal electrical conductor comprises a pair of pin receivers connected by a linking bar.

23. The circuitry of claim 21 wherein each jumper connector comprises a body of insulative material, the internal electrical conductor positioned within the body.

24. The circuitry of claim 21 wherein the grid is positioned on a printed circuit board.

25. The circuitry of claim 21 wherein the jumper connectors are retained on an adjacent pair of pins by a press-fit connection.

26. A signaling system comprising:
an automated machine;
a signaling light beacon positioned on the automated machine, the signaling light beacon comprising a plurality of differently colored light modules, the signaling light beacon housing circuitry for providing both steady and flashing light capabilities within each of the light modules, wherein each light module represents a different facet of operation of the automated machine.

27. The signaling system of claim 26 wherein each light module is wired to the machine for turning the light modules either on or off automatically based on machine performance.

28. The signaling system of claim 26 further comprising a jumper connector for each light module for selecting steady or flashing light.

29. The signaling system of claim 28 wherein the circuitry comprises:
a lamp connection for each light module;
a first line connected to ground;
a flasher circuit; and,
a second line connected to the flasher circuit;
wherein each jumper connector is selectively connected to either the first line or the second line and wherein, when a jumper connector is moved to connect a lamp connection with the first line, an associated lamp will shine steady, and, when a jumper connector is moved to connect a lamp connection with the second line, an associated lamp will flash.

30. The signaling system of claim 26 comprising a plurality of automated machines and a separate signaling light beacon positioned on each automated machine to be monitored.

31. A method of setting up a light signaling beacon for use on a machine, the method comprising:
providing a light signaling beacon with a plurality of light modules;
determining whether each light module should shine steady light or flashing light when each light module is turned on;
moving a jumper connector for each light module to select between steady light and flashing light; and,
mounting the light signaling beacon to the machine;

32. The method of claim 31 wherein providing a light signaling beacon comprises:
determining a number of operations performed by a machine which require monitoring;
selecting a light signaling beacon having a number of light modules equal to the number of operations requiring monitoring.

33. The method of claim 31 further comprising connecting a jumper connector to ground when the light module should shine a steady light and connecting the jumper connector to a flasher circuit when its associated light module should shine a flashing light.

34. The method of claim 31 wherein the light signaling beacon includes a grid of pins, the grid having a row of pins for each lamp connection, the grid further having three columns of pins, a first column of pins connected to a flasher line, a second column of pins connected to the lamp connections, and a third column of pins connected to a steady line, and further wherein each jumper connector includes an internal electrical conductor for electrically connecting an adjacent pair of pins within each row, wherein moving a jumper connector for each light module to select between steady light and flashing light comprises placing the jumper connector over a pin in the first column and a pin in the second column for selecting a flashing light function and placing the jumper connector over a pin in the second column and a pin in the third column for selecting a steady light function.

35. An apparatus for a signaling light beacon, the apparatus comprising:
lamp connections;
a grid of pins, the grid having a row of pins for each lamp connection, the grid further having three columns of pins, a first column of pins connected to a flasher line, a second column of pins connected to the lamp connections, and a third column of pins connected to a steady line;
a jumper connector for each row of pins, each jumper connector having an internal electrical conductor for electrically connecting an adjacent pair of pins within each row.

36. The apparatus of claim 35 wherein the internal electrical conductor comprises a pair of pin receivers connected by a linking bar.

37. The apparatus of claim 36 wherein the pins have a square cross-sectional shape and the pin receivers make electrical contact with each pin received therein.

38. The apparatus of claim 36 wherein the jumper connector includes a window, a portion of the linking bar visible through the window.

39. The apparatus of claim 35 wherein each jumper connector comprises a body of insulative material, the internal electrical conductor positioned within the body.

40. The apparatus of claim 39 wherein the body includes a grasping end 304 and a connecting end 306, the connecting end having an opening housing the internal electrical conductor.

41. The apparatus of claim 40 wherein the grasping end includes ridges.

42. The apparatus of claim 40 wherein the connecting end is wider than the grasping end.

43. The apparatus of claim 35 further comprising a flasher circuit connected to the flasher line.

44. The apparatus of claim 35 wherein the grid includes a base, the pins mounted upon the base.

45. The apparatus of claim 35 wherein the apparatus is a printed circuit board.

46. The apparatus of claim 35 wherein the jumper connectors are retained on an adjacent pair of pins by a press-fit connection.
